(19) United States
(12) Patent Application Publication
(10) Pub. No.: US 2026/0051333 A1
(43) Pub. Date: Feb. 19, 2026

(54) Gimbal Strut Configuration With A No Mid Strut Design

(71) Applicant: Magnecomp Corporation, Murrieta, CA (US)

(72) Inventors: Kuen Chee Ee, Chino, CA (US); Long Zhang, Winchester, CA (US); David Glaess, Bangkok (TH); Treesoon Kotchaplayuk, Wangnoi (TH)

(21) Appl. No.: 19/288,651

(22) Filed: Aug. 1, 2025

Related U.S. Application Data
(63) Continuation-in-part of application No. 19/275,850, filed on Jul. 21, 2025.
Application No. 19/275,850 is a continuation-in-part of application No. 18/376,966, filed on Oct. 5, 2023, now Pat. No. 12,367,899.
Application No. 18/376,966 is a continuation of application No. 17/504,187, filed on Oct. 18, 2021, now abandoned.
(60) Provisional application No. 63/094,215, filed on Oct. 20, 2020.

(51) Int. Cl. G11B 5/48

(52) U.S. Cl. CPC G11B 5/4826; G11B 5/484

(57) ABSTRACT

A trace gimbal is described. The trace gimbal includes outer struts including a front outrigger at a distal end of the trace gimbal and a rear outrigger at a proximal end of the trace gimbal. The trace gimbal also includes a connecting strut connecting to the front outrigger and the rear outrigger. The connecting strut can have a width greater than a width of the outriggers. An inner strut can be connected to the connecting strut at a first end and a slider tongue at a second end.

### CROSS-REFERENCE TO RELATED APPLICATIONS

This application is a continuation-in-part of U.S. Application No. Ser. No. 19/275,850 filed on Jul. 21, 2025, which is a continuation-in-part of U.S. Application No. Ser. No. 18/376,966 filed on Oct. 5, 2023, now U.S. Pat. No. 12,367,899, which is a continuation of U.S. Application No. Ser. No. 17/504,187 filed on Oct. 18, 2021, now abandoned, which claims the benefit of U.S.

Provisional Application No. 63/094,215 filed on Oct. 20, 2020, which are hereby incorporated by reference in their entireties.

### FIELD

This disclosure relates to the field of suspensions for hard disk drives. More particularly, this disclosure relates to the field of gimbal struts on an actuated suspension.

### BACKGROUND

In a dynamic disk storage device, a rotating disk is employed to store information. Disk storage devices typically include a frame to provide attachment points and orientation for other components, and a spindle motor mounted to the frame for rotating the disk. A read/write head is formed on a head slider for writing and reading data to and from the disk surface. The head slider is supported and properly oriented in relationship to the disk by a suspension that provides both the force and compliance necessary for proper head slider operation. As the disk in the storage device rotates beneath the head slider and head suspension, the air above the disk also rotates, thus creating an air bearing which acts with an aerodynamic design of the head slider to create a lift force on the head slider. The lift force is counteracted by a spring force of the suspension, thus positioning the head slider at a desired height and alignment above the disk which is referred to as the fly height.

Suspensions for disk drives include a load beam and a flexure. The load beam typically includes a mounting region for mounting the suspension to an actuator of the disk drive, a rigid region, and a spring region between the mounting region and the rigid region. The spring region provides a spring force to counteract the aerodynamic lift force generated on the head slider during the drive operation as described above. The flexure typically includes a gimbal region having a slider mounting surface where the head slider is mounted. The gimbal region is resiliently moveable with respect to the remainder of the flexure in response to the aerodynamic forces generated by the air bearing. The gimbal region permits the head slider to move in pitch and roll directions and to follow disk surface fluctuations.

Disk drive manufacturers continue to develop smaller yet higher storage capacity drives. Storage capacity increases are achieved in part by increasing the density of the information tracks on the disks (i.e., by using narrower and/or more closely spaced tracks). As track density increases, however, it becomes increasingly difficult for the motor and servo control system to quickly and accurately position the read/write head over the desired track. Attempts to improve this situation have included the provision of another or secondary actuator or actuators, such as a piezoelectric, electrostatic or electromagnetic actuator or fine tracking motor, mounted on the head suspension itself. These types of actuators are also known as dual-stage microactuation devices and may be located at the base plate, the load beam or on the flexure.

Some of these attempts to improve tracking and head slider positioning control have included locating the actuators both at the base plate and on the flexure tongue simultaneously. Typically, this type of suspension uses voice coil and the actuator located at the base plate region for a large motion of the read/write head, while uses the actuator located on the flexure tongue for a desired fine movement to position the read/write head over the tracks of the disk drive.

### SUMMARY

A trace gimbal is described. The trace gimbal includes outer struts including a front outrigger at a distal end of the trace gimbal and a rear outrigger at a proximal end of the trace gimbal. The trace gimbal also includes a connecting strut connecting to the front outrigger and the rear outrigger. The connecting strut can have a width greater than a width of the outriggers. An inner strut can be connected to the connecting strut at a first end and a slider tongue at a second end.

In a first example, a trace gimbal is provided. The trace gimbal can include outer struts including a front outrigger at a distal end of the trace gimbal and a rear outrigger at a proximal end of the trace gimbal. The trace gimbal can also include a connecting strut connecting at a first side to the front outrigger and a second side to the rear outrigger. A width of the connecting strut can be greater than a width of any of the front outrigger and the rear outrigger. The trace gimbal can also include an inner strut extending between the connecting strut to a slider tongue.

In some instances, the width of the connecting strut at least twice the width of any of the front outrigger and the rear outrigger.

In some instances, the connecting strut connects to the front outrigger at the first side at an angle such that a junction between the connecting strut and the front outrigger forms an acute angle.

In some instances, the connecting strut is orthogonal to the rear outrigger at the second side such that a junction between the connecting strut and the rear outrigger forms a substantially right angle.

In some instances, the connecting strut and the slider tongue are substantially in parallel with a lateral axis, and wherein the inner strut comprises an angled surface disposed at an angle relative to the lateral axis.

In some instances, the inner strut comprises an elbow extending from the inner strut.

In some instances, a width of the inner strut between the elbow and the angled surface is greater than the width of the connecting strut.

In some instances, the front outrigger includes a distal front outrigger and a proximal front outrigger, the rear outrigger includes a distal rear outrigger and a proximal rear outrigger.

In some instances, the trace gimbal further comprises at least one microactuator mounted on the slider tongue, wherein the connecting strut supports the slider tongue.

In another example embodiment, a suspension is provided. The suspension can include a trace gimbal including outer struts including a front outrigger at a distal end of the trace gimbal and a rear outrigger at a proximal end of the trace gimbal, the front outrigger includes a distal front outrigger and a proximal front outrigger, the rear outrigger includes a distal rear outrigger and a proximal rear outrigger. The trace gimbal can also include a connecting strut connecting at a first side to the front outrigger and a second side to the rear outrigger, wherein a width of the connecting strut is greater than a width of any of the front outrigger and the rear outrigger. The trace gimbal can also include an inner strut extending between the connecting strut to a slider tongue.

In some instances, the width of the connecting strut at least twice the width of any of the front outrigger and the rear outrigger.

In some instances, the connecting strut connects to the front outrigger at the first side at an angle such that a junction between the connecting strut and the front outrigger forms an acute angle.

In some instances, the connecting strut is orthogonal to the rear outrigger at the second side such that a junction between the connecting strut and the rear outrigger forms a substantially right angle.

In some instances, the connecting strut and the slider tongue are substantially in parallel with a lateral axis, and wherein the inner strut comprises an angled surface disposed at an angle relative to the lateral axis.

In some instances, the inner strut comprises an elbow extending from the inner strut.

In some instances, a width of the inner strut between the elbow and the angled surface is greater than the width of the connecting strut.

While multiple examples are disclosed, still other examples of the present disclosure will become apparent to those skilled in the art from the following detailed description, which shows and describes illustrative examples of this disclosure. Accordingly, the drawings and detailed description are to be regarded as illustrative in nature and not restrictive.

### BRIEF DESCRIPTION OF THE DRAWINGS

In order to describe the manner in which the above-recited and other advantages and features of the disclosure can be obtained, a more particular description of the principles described above will be rendered by reference to specific examples illustrated in the appended drawings. These drawings depict only example aspects of the disclosure and are therefore not to be considered as limiting of its scope. The principles are described and explained with additional specificity and detail using the following drawings.

FIG. 1 illustrates a top perspective view of a magnetic disk drive unit including a microactuator dual stage actuation (DSA) suspension, according to an example of the disclosure.

FIG. 2A illustrates a top plan view of a DSA suspension, according to an example of the disclosure.

FIG. 2B illustrates a top plan view of a tri-stage actuation (TSA) suspension, according to an example of the disclosure.

FIG. 3 illustrates a gimbal assembly of the trace gimbal of the suspension of FIG. 2, according to an example.

FIG. 4 illustrates a mid-strut joint of the trace gimbal of FIG. 3, according to an example of this disclosure.

FIG. 5 is a graph of the PZT frequency response function of a suspension incorporating the mid-strut joint of FIG. 4, according to a simulation.

FIG. 6 illustrates a trace gimbal of a suspension, according to an alternative example of the disclosure.

FIG. 7 illustrates a mid-strut joint of the trace gimbal of FIG. 6, according to an example of this disclosure.

FIG. 8 is a graph of the PZT frequency response function of a suspension incorporating the mid-strut joint of FIG. 6, according to a simulation.

FIG. 9 illustrates an example suspension with a no mid-strut design, according to an example of this disclosure.

### DETAILED DESCRIPTION

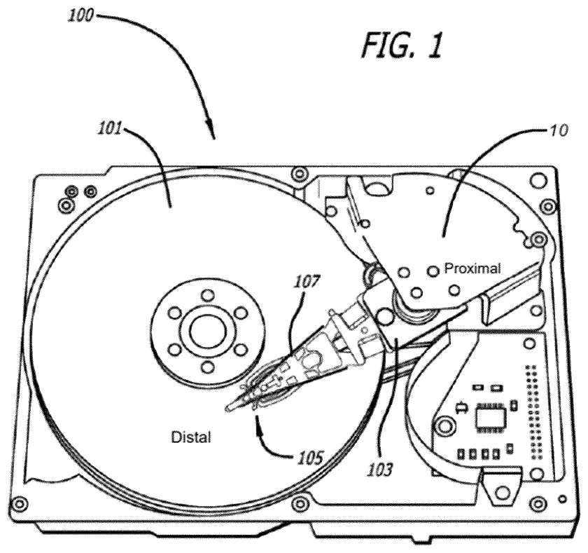

FIG. 1 is a top perspective view of a magnetic disk drive unit 100. The disk drive unit 100 includes a spinning magnetic disk 101, which contains a pattern of magnetic ones and zeroes on it that constitutes the data stored on the disk drive. The magnetic disk 101 is driven by a drive motor. The disk drive unit 100, according to some examples, includes a suspension 105 with a load beam 107, a base plate 103, and a trace gimbal to which a magnetic head slider is mounted proximate the distal end of the trace gimbal. The proximal end of a suspension or load beam is the end that is supported, i.e., the end nearest to a base plate 103 which is swaged or otherwise mounted to an actuator arm. The distal end of a suspension or load beam is the end that is opposite the proximal end, i.e., the distal end is the cantilevered end.

The trace gimbal is coupled to a base plate 103, which in turn is coupled to a voice coil motor 10. The voice coil motor 10 is configured to move the suspension arcuately in order to position the head slider over the correct data track on the magnetic disk 101. The head slider is carried on a gimbal (not shown), which allows the slider to pitch and roll so that it follows the proper data track on the spinning magnetic disk 101, allowing for such variations without degraded performance. Such variations typically include vibrations of the disk, inertial events such as bumping, and irregularities in the disk's surface.

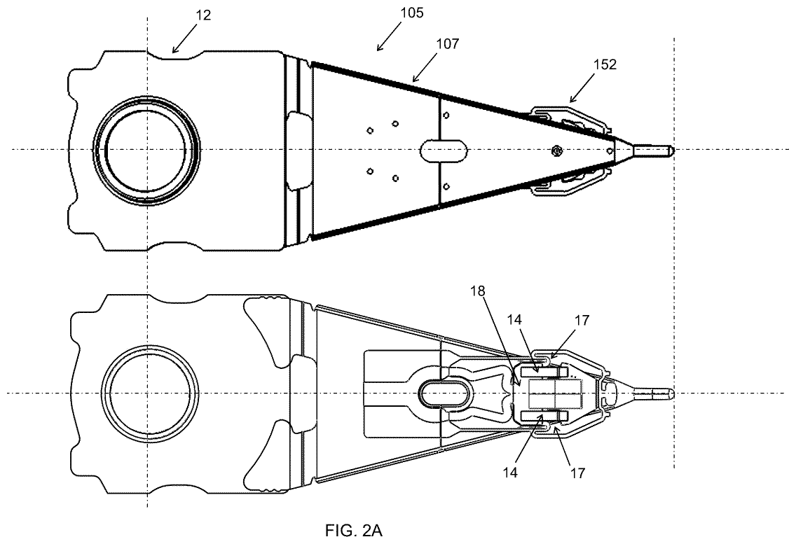

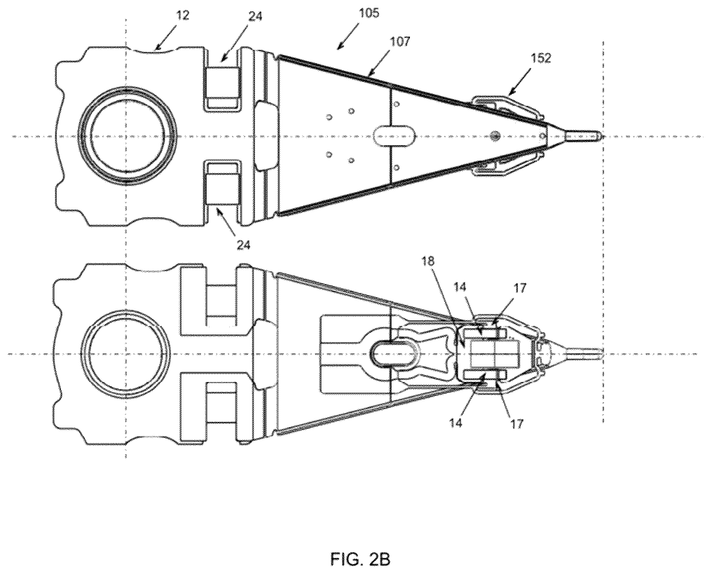

FIG. 2A is a top plan view of a dual stage actuation suspension 105, in accordance with an example of the disclosure. The DSA suspension 105 can include a base plate 12, and a load beam 107. The load beam 107 includes a trace gimbal 152. The trace gimbal 152 can include mounted actuators and a gimbal assembly. The actuators are operable to act directly on the gimbaled assembly of the DSA suspension 105 that is configured to include the read/write head slider.

The trace gimbal 152 can include at least one actuator joint 17 configured to receive an actuator 14. FIG. 2A illustrates two actuator joints 17, located on opposing sides of the trace gimbal 152. Each actuator joint 17 includes actuator mounting shelves.

Each actuator 14 spans the respective gap in the actuator joint 17. The actuators 14 are affixed to the slider tongue 18 by an adhesive. The adhesive can include conductive or nonconductive epoxy strategically applied at each end of the actuators. The positive and negative electrical connections can be made from the actuators 14 to the trace gimbal 152 by a variety of techniques. When the actuator 14 is activated, it expands or contracts producing movements of the read/write head that is mounted at the distal end of suspension 105 thereby changing the length of the gap between the mounting ends.

The suspension 105 can be configured as a single-stage actuation suspension, a dual-stage actuation device, a tri-stage actuation device or other configurations. One example of the tri-stage actuation suspension is shown in FIG. 2B, where the actuators 14 and 24 are respectively located at the mount plate region and on the flexure tongue at the same time.

Conceivably, any variation of actuators can be incorporated onto suspension 105 for the purposes of the examples disclosed herein. In other words, the suspension 105 may include more or less components than those shown without departing from the scope of the present disclosure. The components shown, however, are sufficient to disclose an illustrative example for practicing the disclosed principles.

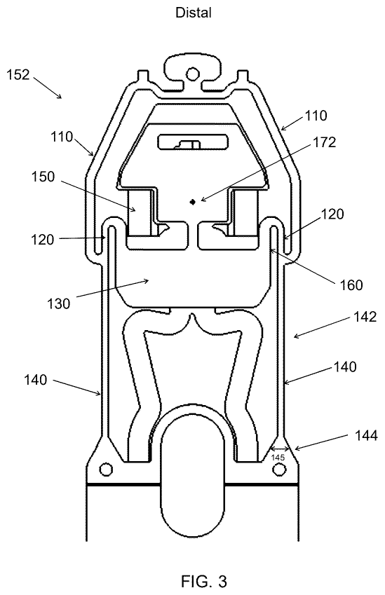

FIG. 3 illustrates a gimbal assembly of the trace gimbal 152, according to an example. The trace gimbal 152 includes at least one microactuator 150 mounted on a slider tongue 130. The trace gimbal 152 includes outer gimbal struts. The outer struts include the front outrigger 110 at a distal end of the trace gimbal 152. The outer struts also include rear outrigger 140 at a proximal end of the trace gimbal 152. The trace gimbal 152 also includes a middle strut 120 extending from the rear outrigger 140 and connecting the front outrigger 110 to the rear outrigger 140. In other words, the front outrigger 110 and the rear outrigger 140 adjoin at the proximal end of the middle strut 120. The trace gimbal 152 also includes an inner strut 160 extending from the slider tongue 130 and connecting the middle strut 120 to the slider tongue 130. The inner strut 160 supports the slider tongue 130 onto which a read/write head is assembled.

The front outrigger 110, the rear outrigger 140, the middle strut 120, and the inner strut 160 (collectively referred to as “struts”) are configured to bend to allow the slider to pitch or roll when flying on the disk. The struts have high lateral stiffness to attain high yaw frequency, yet are flexible enough to allow the slider to pitch or roll about the dimple 172. To accomplish this, according to some examples, the struts have varying cross sectional sizes. For example, the struts are bowed and/or bent as shown for example in FIG. 3 to provide flexibility for pitch and roll stiffness. The middle strut 120 and the inner strut 160 are adjoined at a mid-strut joint.

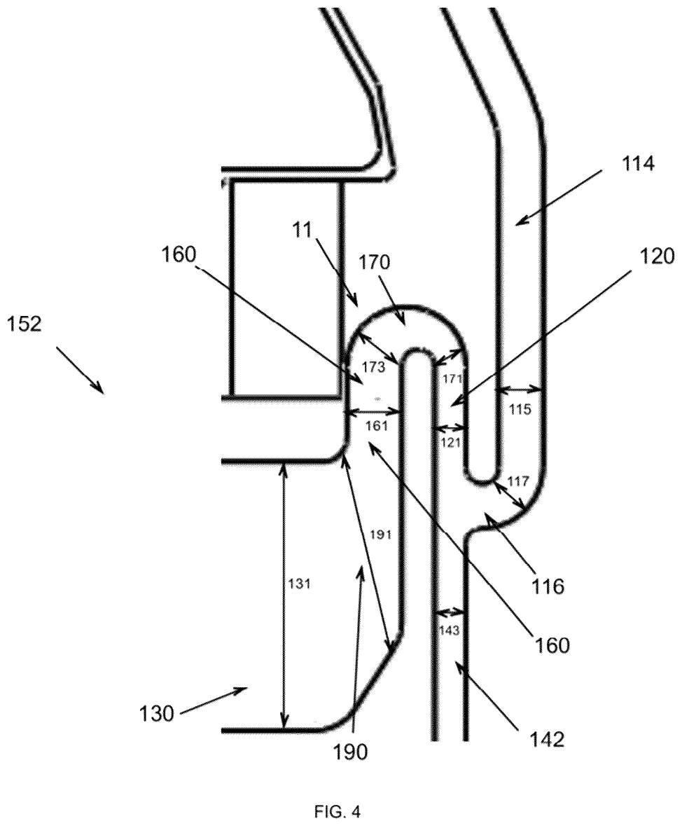

FIG. 4 illustrates the mid-strut joint 11 of the trace gimbal 152, according to an example. The mid-strut joint 11 includes a proximal front outrigger 114 adjoined to a distal rear outrigger 142 at a first juncture 116. The proximal front outrigger 114 can include a first cross-section 115, and a second cross-section 117 at the first juncture 116. The second cross-section 117 is equal or larger than the first cross-section 115 of the proximal front outrigger 114. The distal rear outrigger 142 can include a first cross-section 143, while a proximal rear outrigger 144 has a second cross-section 145 (in FIG. 3), larger than the first cross-section 143. The middle strut 120 includes a cross-section 121, which is also smaller than the second cross-section 145 (in FIG. 3) of the proximal rear outrigger 144.

The middle strut 120 is adjoined to the inner strut 160 at a second juncture 170. The second juncture 170 includes a first cross-section 171 at the middle strut 120. The second juncture 170 also includes a second cross-section 173 at the inner strut 160, where the second cross-section 173 is larger than the first cross-section 171. The inner strut 160 includes a cross-section 161. The inner strut 160 is adjoined to the slider tongue 130 at a third juncture 190. The third juncture 190 includes a cross-section 191. The slider tongue 130 includes a cross-section 131, that is larger than the cross-section 191 of the third juncture 190, which is larger than the cross-section 161 of the inner strut 160.

The varying cross-sections of the distal rear outrigger 142, the proximal rear outrigger 144, and the proximal front outrigger 114 impacts the performance of a suspension device with such a trace gimbal 152.

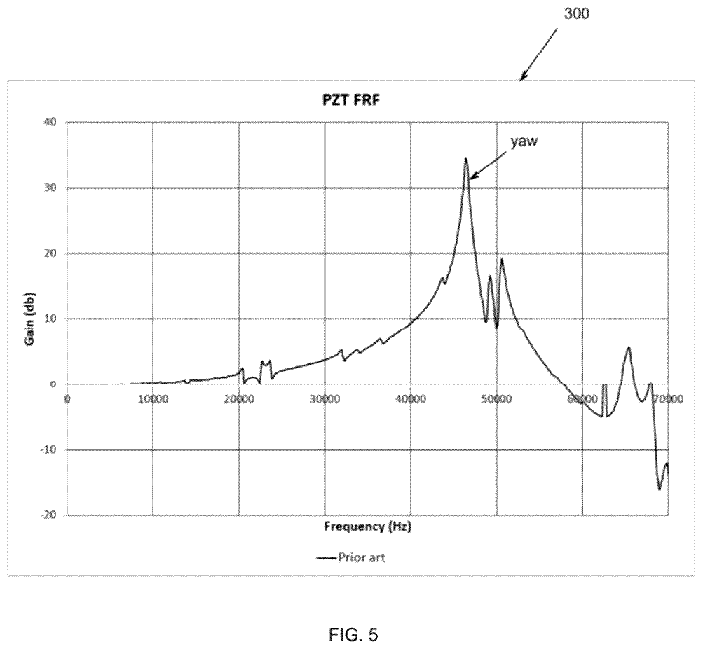

FIG. 5 is a graph 300 of the microactuator (PZT) frequency response function of a suspension incorporating the trace gimbal 152, according to a simulation. The suspension exhibited a yaw frequency below 50kHz. Because the yaw mode gain is the highest peak across the frequency band of the frequency response function, a deep notch filter is needed to be placed at the yaw mode for its gain attenuation, which sets the limit of the servo bandwidth.

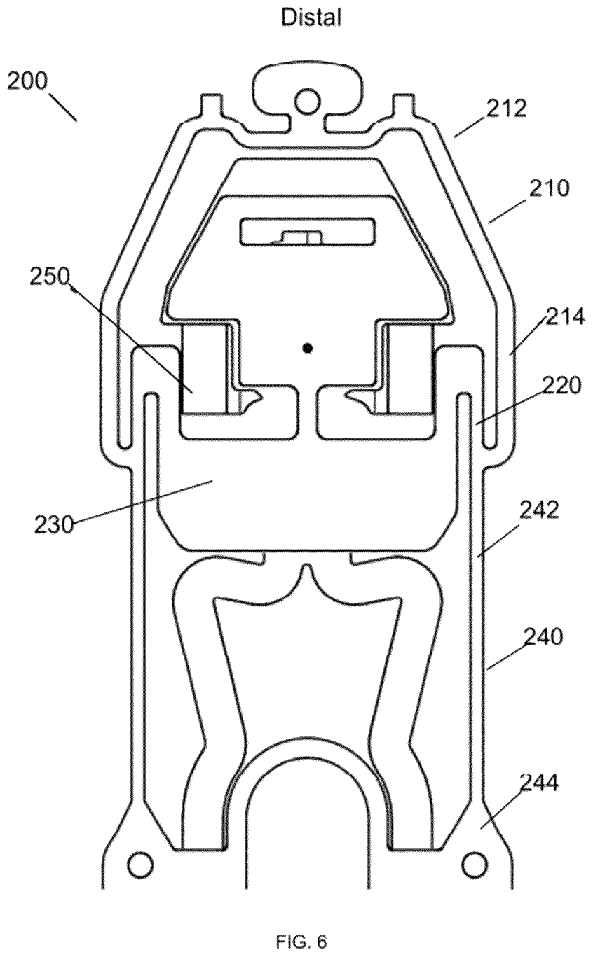

FIG. 6 illustrates a trace gimbal 200 of a suspension, according to an example of the disclosure. The trace gimbal 200 includes at least one microactuator 250 mounted on a slider tongue 230. The trace gimbal 200 includes outer gimbal struts. The outer struts include the front outrigger 210 at a distal end of the trace gimbal 200, the front outrigger 210 includes a distal front outrigger 212 and a proximal front outrigger 214. In some examples, the distal front outrigger 212 and the proximal front outrigger 214 are defined by a bend or non-linear feature of the front outrigger 210. In other examples, the distal front outrigger 212 and the proximal front outrigger 214 are non-distinguishable, and may be adjoined at a linear feature that does not physically separate the two features.

The outer struts also include rear outrigger 240 at a proximal end of the trace gimbal 200, the rear outrigger 240 includes a distal rear outrigger 242 and a proximal rear outrigger 244. In some examples, the distal rear outrigger 242 and the proximal rear outrigger 244 are defined by a bend or non-linear feature of the rear outrigger 240. In other examples, the distal rear outrigger 242 and the proximal rear outrigger 244 are non-distinguishable, and may be adjoined at a linear feature that does not physically separate the two features.

The trace gimbal 200 also includes a middle strut 220 extending from the distal rear outrigger 242 and adjoining the proximal front outrigger 214 to the rear outrigger 240. In other words, the front outrigger 210 and the rear outrigger 240 adjoin at the proximal end of the middle strut 220. The middle strut 220 also extends from the slider tongue 230 adjoining the outer gimbal struts to the slider tongue 230. The middle strut 220 supports the slider tongue 230 onto which a read/write head is assembled. The trace gimbal 200 avoids the bowed and/or bent element of an inner strut 260 with a cross-section 261, thereby improving the stiffness of the trace gimbal 200.

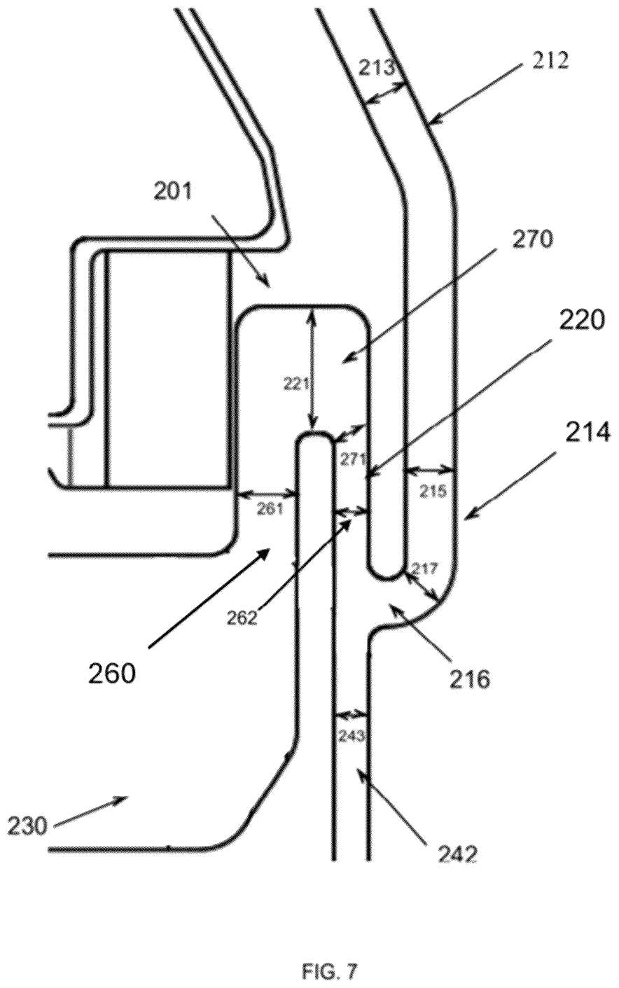

FIG. 7 illustrates a mid-strut joint 201 of the trace gimbal 200, according to an example of this disclosure. The mid-strut joint 201 includes a proximal front outrigger 214 adjoined to a distal rear outrigger 242 at a first juncture 216. The proximal front outrigger 214 can include a first cross-section 215, and a second cross-section 217 at the first juncture 216. The second cross-section 217 is about the same dimension as the first cross-section 215 of the proximal front outrigger 214. One of ordinary skill in the art understands that two machined components are rarely the same dimension. Therefore, the dimensions discussed herein with respect to the illustrated examples account for manufacturing tolerances and in practice are not expected to be exact. The distal rear outrigger 242 can include a cross-section 243. The middle strut 220 includes a cross-section 262, which is about the same dimension as the cross-section 243 of the distal rear outrigger 242.

The middle strut 220 is adjoined to the slider tongue 230 at a second juncture 270. The second juncture 270 includes a cross-section 271 at the middle strut 220. The cross-section 271 of the second juncture 270 is about the same dimension as the cross-section 262 of the middle strut 220. The slider tongue 230 includes a mid-strut joint length L 221, that is greater than the cross-section 271 of the second juncture 270.

Specifically, the mid-strut joint 201 may have a mid-strut length L 221 between 0.20 mm and 0.40 mm. In some examples, the mid-strut length L 221 is 0.25 mm. The first cross-section 213 and the second cross-section 215 of the front outrigger 210 is between 0.05 mm and 0.10 mm. In some examples, the width of both cross-sections is 0.09 mm. The cross-section 243 of the distal rear outrigger 242 is between 0.10 mm and 0.20 mm. In some examples, the width of the cross-section 243 is 0.12 mm. The middle strut 220 connects to the slider tongue 230 at a position that substantially increases the mid strut joint length, compared to the trace gimbal of FIG. 3. In some examples, the mid strut joint length 221 is more than two-times the mid strut joint length of the trace gimbal of FIG. 3.

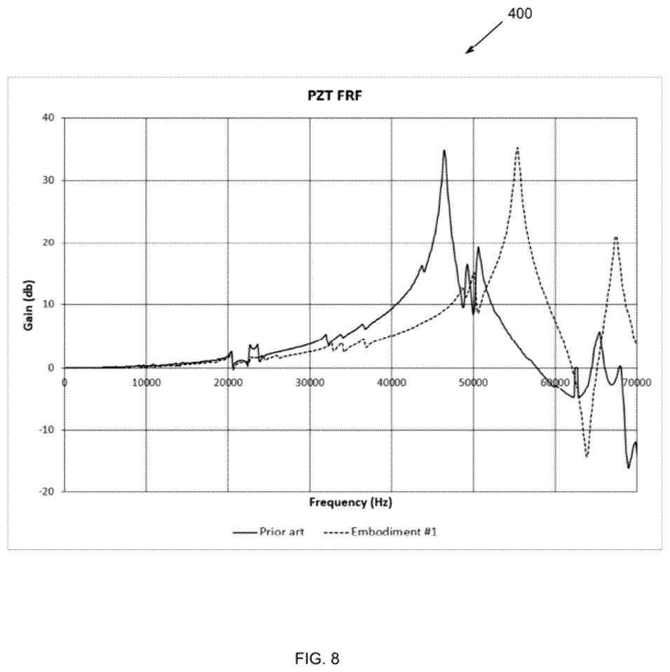

FIG. 8 is a graph 400 of the microactuator (PZT) frequency response function of a suspension incorporating the mid-strut joint of FIG. 7, according to a simulation. The increased mid strut joint length increases the yaw frequency. For example, a 0.1 mm increase in mid strut joint length lead to the yaw frequency increase by 8 kHz to 65.0 kHz. In addition, the mid strut joint length increase also improves the 24 kHz mode (the torsion mode) as it increases its phase lag to decrease the gain.

In some instances, the suspension can include a no mid-strut design. Such designs can include a width of the connecting strut being greater than a width of the outriggers.

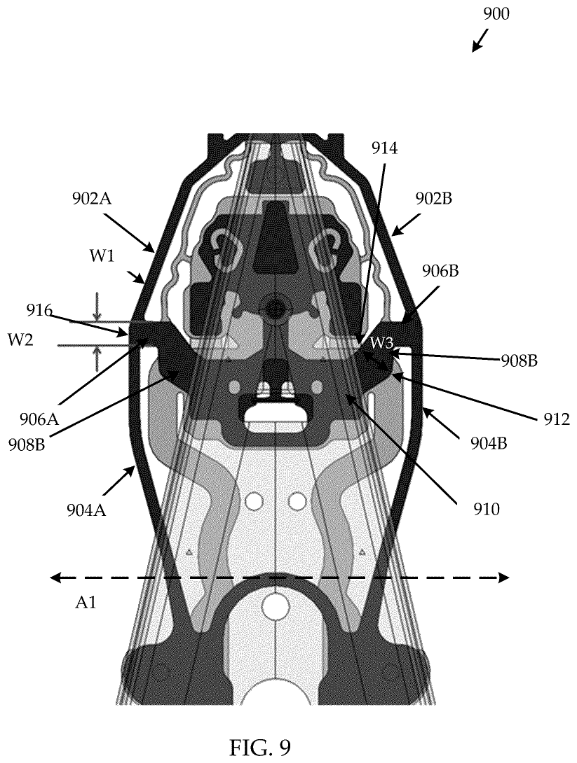

FIG. 9 illustrates an example suspension 900 with a no mid-strut design. As shown in FIG. 9, the suspension can include front outriggers 902A-B and rear outriggers 904A-B. Each of the front outriggers 902A-B and rear outriggers 904A-B can have a width W1. In some instances, front outriggers 902A-B and rear outriggers 904A-B can have the same or differing widths. Front outriggers 902A-B and rear outriggers 904A-B can have widths ranging from around .07 mm to .10 mm, for example.

A connecting strut 906A-B can connect each front outrigger 902A-B to the corresponding rear outrigger 904A-B at junction 916. The connecting strut 906A-B can have a width at junction 916 W2 greater than the width W1 of outriggers 902A-B. In some instances, width W2 can be at least twice the width W1. The width of the connecting strut 906A-B can be around twice of width W1, which can include a range of around 0.15 mm to 0.25 mm. The width of the inner strut can be around three times the width W1, which can include a range of 0.20 mm to 0.35 mm at its widest point.

The connecting strut 906A-B can connect to the front outrigger 902A-B at a first side and to the corresponding rear outrigger 904A-B at a second side opposing the first side. In some instances, an angle formed at the junction connecting the connecting strut 906A-B to the front outrigger 902A-B at the first side can form an acute angle, and the junction connecting the connecting strut 906A-B to the second outrigger 902A-B at the second side can form about a right angle. The connecting strut and the slider tongue can be substantially in parallel with a lateral axis A1 along a width of the trace gimbal.

The connecting strut 906A-B can connect to an inner strut 908A-B that is disposed between the connecting strut 906A-B and the slider tongue 910. The inner strut 908A-B can be disposed at an angle relative to the connecting strut 906A-B. For instance, the inner strut 908A-B can include an angled surface 914 disposed at an angle relative to the connecting strut 906A-B. The angled surface 914 can be disposed at an angle relative to the lateral axis. Further, the inner strut 908A-B can include an elbow 912 extending from the inner strut 908A-B. A distance of the inner strut 908A-B between the angled surface 914 and elbow 912 W3 can be greater than the width of the connecting strut W2.

While multiple examples are disclosed, still other examples within the scope of the present disclosure will become apparent to those skilled in the art from the detailed description provided herein, which shows and describes illustrative examples. Accordingly, the drawings and detailed description are to be regarded as illustrative in nature and not restrictive. Features and modifications of the various examples are discussed herein and shown in the drawings. While multiple examples are disclosed, still other examples of the present disclosure will become apparent to those skilled in the art from the following detailed description, which shows and describes illustrative examples of this disclosure. Accordingly, the drawings and detailed description are to be regarded as illustrative in nature and not restrictive.

What is claimed is:

1. A trace gimbal comprising:
outer struts including a front outrigger at a distal end of the trace gimbal and a rear outrigger at a proximal end of the trace gimbal;
a connecting strut connecting at a first side to the front outrigger and a second side to the rear outrigger, wherein a width of the connecting strut is greater than a width of any of the front outrigger and the rear outrigger; and
an inner strut extending between the connecting strut to a slider tongue.

2. The trace gimbal of claim 1, wherein the width of the connecting strut at least twice the width of any of the front outrigger and the rear outrigger.

3. The trace gimbal of claim 1, wherein the connecting strut connects to the front outrigger at the first side at an angle such that a junction between the connecting strut and the front outrigger forms an acute angle.

4. The trace gimbal of claim 1, wherein the connecting strut is orthogonal to the rear outrigger at the second side such that a junction between the connecting strut and the rear outrigger forms a substantially right angle.

5. The trace gimbal of claim 1, wherein the connecting strut and the slider tongue are substantially in parallel with a lateral axis, and wherein the inner strut comprises an angled surface disposed at an angle relative to the lateral axis.

6. The trace gimbal of claim 5, wherein the inner strut comprises an elbow extending from the inner strut.

7. The trace gimbal of claim 6, wherein a width of the inner strut between the elbow and the angled surface is greater than the width of the connecting strut.

8. The trace gimbal of claim 1, wherein the front outrigger includes a distal front outrigger and a proximal front outrigger, the rear outrigger includes a distal rear outrigger and a proximal rear outrigger.

9. The trace gimbal of claim 1, further comprising at least one microactuator mounted on the slider tongue, wherein the connecting strut supports the slider tongue.

10. A suspension comprising:
a trace gimbal including:
outer struts including a front outrigger at a distal end of the trace gimbal and a rear outrigger at a proximal end of the trace gimbal, the front outrigger includes a distal front outrigger and a proximal front outrigger, the rear outrigger includes a distal rear outrigger and a proximal rear outrigger;
a connecting strut connecting at a first side to the front outrigger and a second side to the rear outrigger, wherein a width of the connecting strut is greater than a width of any of the front outrigger and the rear outrigger; and
an inner strut extending between the connecting strut to a slider tongue.

11. The suspension of claim 10, wherein the width of the connecting strut at least twice the width of any of the front outrigger and the rear outrigger.

12. The suspension of claim 10, wherein the connecting strut connects to the front outrigger at the first side at an angle such that a junction between the connecting strut and the front outrigger forms an acute angle.

13. The suspension of claim 10, wherein the connecting strut is orthogonal to the rear outrigger at the second side such that a junction between the connecting strut and the rear outrigger forms a substantially right angle.

14. The suspension of claim 10, wherein the connecting strut and the slider tongue are substantially in parallel with a lateral axis, and wherein the inner strut comprises an angled surface disposed at an angle relative to the lateral axis.

15. The suspension of claim 14, wherein the inner strut comprises an elbow extending from the inner strut.

16. The suspension of claim 15, wherein a width of the inner strut between the elbow and the angled surface is greater than the width of the connecting strut.
